(19) United States
(12) Patent Application Publication
(10) Pub. No.: US 2010/0108510 A1
(43) Pub. Date: May 6, 2010

(54) MEASURING DEVICE FOR MONITORING THE CORROSION OF A STEEL REINFORCEMENT

(75) Inventor: Wolfgang HILL, Boppard-Buchholz (DE)

Correspondence Address: SHUTTLEWORTH & INGERSOLL, P.L.C., 115 3RD STREET SE, SUITE 500, P.O. BOX 2107, CEDAR RAPIDS, IA, 52406, US

(73) Assignee: SELFSAN CONSULT GMBH, Boppard (DE)

(21) Appl. No.: 12/572,582

(22) Filed: Oct. 2, 2009

(30) Foreign Application Priority Data
Oct. 4, 2008 (DE) 10 2008 050 478.5

(51) Int. Cl. G01N 27/26

(52) U.S. Cl. 204/404

(57) ABSTRACT

A measuring device (1) for monitoring materials that affect corrosion of a steel reinforcement (2) in a concrete part (3) includes a sensor (4), which can be disposed inside the concrete part (3) in the vicinity of the steel reinforcement (2), and an external electronic evaluation device (5), which can be disposed outside the concrete part (3). At least two axially spaced-apart, wire-like probes (9, 9′), wrapped in loop-like fashion around the housing (6), are disposed on the outside of the housing wall (8) of the sensor (4), which probes have a different spacing from the steel reinforcement (2) to be monitored, so that the course over time of the corrosion progressing in the direction of the steel reinforcement (2) is ascertainable by the external electronic evaluation device (5).

This application claims priority to German Patent Application No. 10 2008 050 478.5 filed Oct. 4, 2008, which application is incorporated by reference herein.

The invention relates to a measuring device for monitoring the substances that affect the corrosion of a steel reinforcement in a concrete part.

One such measuring device is known from German Utility Model DE 20 2006 009 541 U1. It includes a sensor, which can be disposed inside the concrete part in the vicinity of the steel reinforcement, and an external electronic evaluation device, which can be disposed outside the concrete part. The sensor has a housing of an electrically nonconductive material, on the outside of the housing wall of which a probe is disposed, which comprises a material that corresponds to the corrosion properties of the steel reinforcement. The probe is connected an electronic device which is disposed in the housing and which at predeterminable time intervals ascertains the state of corrosion of the probe and forwards the measured values in wireless fashion to the external electronic evaluation device with the aid of a transceiver.

A disadvantage of this known measuring device is that only corrosion that has already begun is ascertained, but no prediction can be made about the course or speed of the corrosion.

From German Patent Disclosure DE 38 34 628 A1, a measuring device for monitoring the materials that affect the corrosion of a steel reinforcement in a concrete part is also known, in which the sensor essentially comprises two probes (electrodes) spaced apart from one another. One probe comprises normal concrete steel, and one probe comprises a more-noble metal which is protected against corrosion even in carbonized concrete or in concrete that contains chloride. These probes are connected via electrical connecting lines to the evaluation device, which can be disposed outside the concrete part and detects the occurrence of an electrical current that develops between the probes upon the onset of corrosion of the concrete steel electrode.

In order to determine the progressing course of the leading edge of corrosion more precisely, it is proposed in this reference that the intensity of corrosion be measured at different depths in the concrete layer, and a plurality of probes spaced apart from one another and made of concrete steel are disposed at different depths and are connected electrically via electrical lines to a probe of more-noble metal that is located closer to the surface. Thus electrochemical tension elements are formed at various depths, so that when corrosion begins in the particular probe made of concrete steel, the current that develops between the probes changes.

One disadvantage of this known measuring device, among others, is that the measurement lines must be extended out of the concrete layer, and that the measured values are dependent not only on pollutants located in the concrete but also on the density of the concrete at the measurement points as well as on the temperature prevailing there, and these must therefore be taken into account in evaluating the measured values.

With DE 20 2006 009 541 U1 as a point of departure, it is the object of the invention to disclose a measuring device of simple and sturdy construction, with which reliable measured values about a course of corrosion inside a concrete part provided with a steel reinforcement can be obtained.

The invention is based essentially on the concept that on the outside of the housing wall of the sensor, at least two axially spaced-apart, wire-like probes are disposed in loop-like fashion wrapped around the housing and have a different spacing from the steel reinforcement to be monitored, so that the course over time of the corrosion progressing in the direction of the steel reinforcement can be ascertained by the external electronic evaluation device.

It is advantageous that each of the two measuring sensors is assigned its own electronic device in the housing, for instance made of plastic, of the sensor, and each electronic device is in wireless communication with the external electronic evaluation device.

The applicable electronic device is advantageously constructed such that upon reaching a predetermined limit value of the corrosion of the applicable probe, the electronic device assigned to that probe sends a signal to the external evaluation device. It may be provided that the limit value is defined by the destruction of the applicable probe from corrosion.

The probe should preferably comprise a material which corresponds to the corrosion properties of the steel reinforcement in the applicable pollutant environment.

The external electronic evaluation device may be a handheld scanner or a measurement station.

Furthermore, the external electronic evaluation device and the electronic devices of the sensor can cooperate such that the state of corrosion of the probe is called up a predetermined time intervals by use of a telemetry signal and forwarded to a measurement station.

Further details and advantages of the invention will become apparent from the following exemplary embodiment described in conjunction with a drawing.

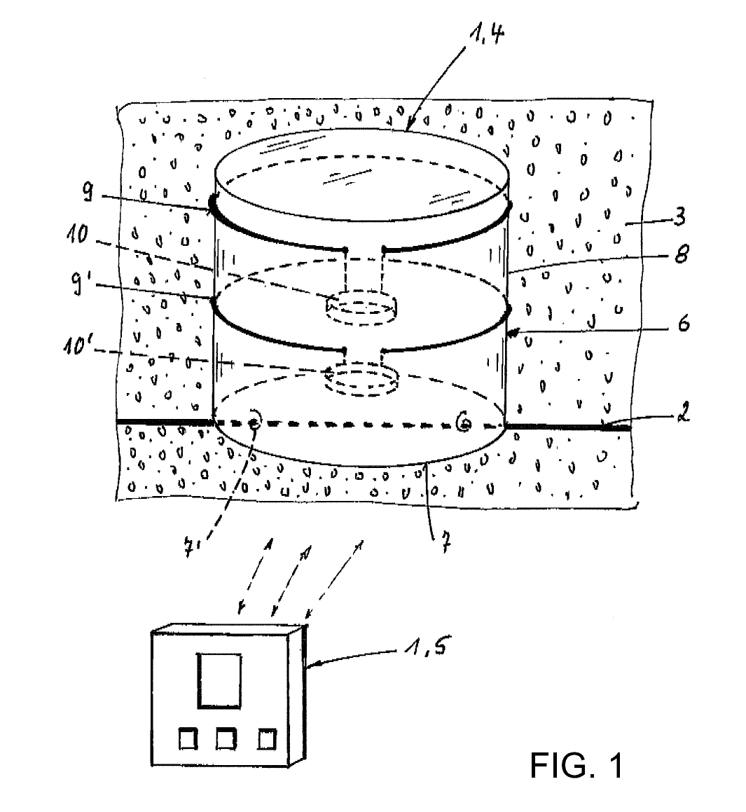

FIG. 1 is a schematic view of the measuring device of the present invention.

In FIG. 1, reference numeral 1 indicates a measuring device according to the invention, which serves to monitor the corrosion of a steel reinforcement 2 in a concrete part 3. The measuring device 1 includes a sensor 4, disposed inside the concrete part 3 in the vicinity of the steel reinforcement 2, and an external electronic evaluation device 5, which can be disposed outside the concrete part 3. In the exemplary embodiment shown in the drawing, the external evaluation device 5 is a handheld scanner, which displays the ascertained corrosion values on a screen.

The sensor 4 includes a cylindrical housing 6, which comprises an electrically nonconductive material, such as plastic, and which is secured by a lower face end 7 to the reinforcement 2 by wire clamps 7′.

Two axially spaced-apart, wire-like probes 9, 9′ wrapped in loop-like fashion around the housing 6 are disposed on the outside of the housing wall 8 of the sensor 4 and have a different spacing from the steel reinforcement 2 to be monitored, so that the course over time of the corrosion progressing in the direction of the steel reinforcement 2 can be ascertained by the external electronic evaluation device 5.

Both probes 9, 9′ comprise a material which corresponds to the corrosion properties of the steel reinforcement 2 in the applicable pollutant environment.

Moreover, each of the two probes 9, 9′ is assigned its own electronic device 10, 10′ in the housing 6 of the sensor 4, which electronic device is in wireless communication with the external electronic evaluation device 5. The two electronic devices 10, 10′ are constructed such that if the applicable probe 9, 9′ is destroyed by corrosion, the electronic device 10, 10′ assigned to that probe 9, 9′ sends a signal to the external evaluation device 5.

### LIST OF REFERENCE NUMERALS

1 Measuring device
2 Steel reinforcement
3 Concrete part
4 Sensor
5 (External) evaluation device
6 Housing
7 Face end
7′ Wire clamp
8 Housing wall
9, 9′ Probe
10, 10′ Electronic device

What is claimed is:

1. A measuring device (1) for monitoring the materials that affect the corrosion of a steel reinforcement (2) in a concrete part (3), having the following characteristics:
a) the measuring device (1) includes a sensor (4), which can be disposed inside the concrete part (3) in the vicinity of the steel reinforcement (2), and an external electronic evaluation device (5), which can be disposed outside the concrete part (3);
b) the sensor (4) has a housing (6) of an electrically nonconductive material, on the outside of the housing wall (8) of which at least one probe (9, 9′) is disposed that comprises a material which corresponds to the corrosion properties of the steel reinforcement (2);
c) the probe (9, 9′) is connected to an electronic device (10, 10′) which is disposed in the housing (6) and at predeterminable time intervals ascertains the state of corrosion of the probe (9, 9′);
d) the electronic device (10, 10′) includes a transceiver for wireless transmission of the state of corrosion of the probe (9, 9′), ascertained by the electronic device (10, 10′), to the external electronic evaluation device (5) and for triggering the electronic device (10, 10′) by the external electronic evaluation device (5),
characterized in that on the outside of the housing wall (8) of the sensor (4), at least two axially spaced-apart, wire-like probes (9, 9′) wrapped in loop-like fashion around the housing (6) are disposed, which have a different spacing from the steel reinforcement (2) to be monitored, so that the course over time of the corrosion progressing in the direction of the steel reinforcement (2) is ascertainable by the external electronic evaluation device (5).

2. The measuring device of claim 1, characterized in that each of the two probes (9, 9′) is assigned its own electronic device (10, 10′) in the housing (6) of the sensor (4), which device is in wireless communication with the external electronic evaluation device (5).

3. The measuring device of claim 2, characterized in that the electronic devices (10, 10′) are constructed such that when a predetermined limit value of corrosion of the applicable probe (9, 9′) is reached, the electronic device (10, 10′) assigned to that probe (9, 9′) sends a signal to the external evaluation device (5).

4. The measuring device as defined by claim 2, characterized in that the two electronic devices (10, 10′) are constructed such that if the applicable probe (9, 9′) is destroyed by corrosion, the electronic device (10, 10′) assigned to that probe (9, 9′) sends a signal to the external evaluation device (5).

5. The measuring device of claim 4, characterized in that the housing (6) of the sensor (4) comprises plastic.

6. The measuring device of claim 5, characterized in that the housing (6) of the sensor (4) is embodied cylindrically.

7. The measuring device of claim 6, characterized in that the probe (9, 9′) comprises a material which corresponds to the corrosion properties of the steel reinforcement (2) in the applicable pollutant environment.

8. The measuring device of claim 7, characterized in that the external electronic evaluation device (5) is a handheld scanner.

9. The measuring device of claim 5, characterized in that the external electronic evaluation device (5) is a measurement station.

10. The measuring device of claim 7, characterized in that the external electronic evaluation device (5) and the electronic devices (10, 10′) of the sensor (4) cooperate in such a manner that the state of corrosion of the probe (9, 9′) is called up at predetermined time intervals by use of a telemetry signal and forwarded to a measurement station.

11. The measuring device of claim 1, characterized in that the housing (6) of the sensor (4) comprises plastic.

12. The measuring device of claim 1, characterized in that the housing (6) of the sensor (4) is embodied cylindrically.

13. The measuring device of claim 1, characterized in that the probe (9, 9′) comprises a material which corresponds to the corrosion properties of the steel reinforcement (2) in the applicable pollutant environment.

14. The measuring device of claim 1, characterized in that the external electronic evaluation device (5) is a handheld scanner.

15. The measuring device of claim 1, characterized in that the external electronic evaluation device (5) is a measurement station.

16. The measuring device of claim 1, characterized in that the external electronic evaluation device (5) and the electronic devices (10, 10′) of the sensor (4) cooperate in such a manner that the state of corrosion of the probe (9, 9′) is called up at predetermined time intervals by use of a telemetry signal and forwarded to a measurement station.
